(19) United States
(12) Patent Application Publication
(10) Pub. No.: US 2021/0188209 A1
(43) Pub. Date: Jun. 24, 2021

(54) GAS GENERATOR PIPE FOR AIRBAG MODULE, AND METHOD FOR MANUFACTURING THE GAS GENERATOR PIPE

(71) Applicant: Benteler Steel/Tube GmbH, Paderborn (DE)

(72) Inventors: Jozef Balun, Schlangen (DE); Niko Große-Heilmann, Harsewinkel (DE); Michael Kaufmann, Paderborn (DE); Nathalieü Weiß-Borkowski, Büren-Brenken (DE); Leonhard Rose, Borchen (DE)

(21) Appl. No.: 17/127,272

(22) Filed: Dec. 18, 2020

(30) Foreign Application Priority Data
Dec. 20, 2019 (DE) 10 2019 135 596.6

(51) Int. Cl. B60R 21/264; B60R 21/261; C21D 1/18; C21D 6/00; C22C 38/44; C22C 38/46; C22C 38/50

(52) U.S. Cl. CPC B60R 21/264; B60R 21/261; C21D 1/18; B60R 2021/2612; C22C 38/44; C22C 38/46; C22C 38/50; C21D 6/002

(57) ABSTRACT

The present invention relates to a gas generator pipe of an airbag module, the gas generator pipe consisting of a steel alloy with a martensitic matrix. The gas generator pipe is characterized in that the gas generator pipe has a tensile strength, Rm, of at least 1,100 MPa, and the steel alloy has the following alloying elements apart from iron and melt-related impurities in mass percent (Ma %):
C 0.05-0.18%
Si 0.4-2.6%
Mn 0.2-1.4 %
Cr 2.0-4.0%
Mo 0.05-1.0%
N <0.015% and
   at least one of the alloying elements Nb, V, Al and Ti in total at least 0.01%,
   the gas generator pipe has been subjected to a quenching and partitioning heat treatment and
   the gas generator pipe has a microstructure of martensite and austenite and the amount of austenite in the microstructure is at least 5%.

Furthermore, the invention relates to a method of manufacturing such a gas generator pipe.

### REFERENCE TO PENDING PRIOR PATENT APPLICATION

This patent application claims benefit of German Patent Application No. 10 2019 135 596.6, filed Dec. 20, 2019, which patent application is hereby incorporated herein by reference.

### FIELD OF THE INVENTION

The present invention relates to a gas generator pipe of an airbag module, and a process for manufacturing such a gas generator pipe.

### BACKGROUND OF THE INVENTION

In gas generators in airbags, high pressure is generated in the gas generator and especially in the gas generator pipe that forms it. The medium under high pressure is then fed into the actual airbag and thereby fills the airbag. Due to the abrupt increase in pressure, the gas generator pipe is abruptly exposed to high force. Bursting of the gas generator pipe has to be prevented, as this would otherwise lead to injury to the occupants of the vehicle.

On the other hand, in order to produce the shape, for example, indents at the ends of the gas generator pipe, it is necessary to be able to cold-form the gas generator pipe in the final phase of the manufacturing process. Cold drawing after heat treatment may also be necessary to compensate for geometric tolerances.

### SUMMARY OF THE INVENTION

It is therefore the task of the present invention to create a gas generator pipe for an airbag module, which can reliably meet these requirements. In addition, a process for the production of this gas generator pipe is to be provided.

The task is solved by the gas generator pipe product with the features of claim 1. Advantageous embodiments can be derived from the dependent claims, the description and the figures.

Accordingly, the invention relates to a gas generator pipe of an airbag module, consisting of a steel alloy with a martensitic matrix. The gas generator pipe is characterized in that the gas generator pipe has a tensile strength, Rm, of at least 1,100 MPa, preferably at least 1,200 MPa, and in that the steel alloy contains the following alloying elements apart from iron and melting-related impurities in mass percent (Ma %):
C 0.05-0.18%
Si 0.4-2.6%
Mn 0.2-1.4%
Cr 2.0-4.0%
Mo 0.05-1.0%
N <0.015% and
   at least one of the alloying elements Nb, V, Al and Ti, in total at least 0.01%
   the gas generator pipe has been subjected to a quenching and partitioning heat treatment and
   the gas generator pipe has a microstructure of martensite and austenite, wherein the portion of austenite is at least 5%.

The gas generator pipe can be a seamless pipe or welded pipe. The gas generator pipe can also be referred to as gas generator tube or tubular product. The gas generator pipe represents a part of a gas generator for an airbag module. The gas generator pipe can also be referred to as a tubular product. The gas generator pipe can have at least two length sections of different outer circumference. In particular, at least one of the pipe ends may have a smaller outer circumference. In particular, a combustion chamber is formed in the gas generator pipe, in which an igniter and other pyrotechnical components are provided. The combustion chamber can be closed with a welded-on pane. A further area adjoining the combustion chamber is usually used as a cold gas storage. The combustion chamber is separated from the cold gas storage by a membrane, which can also be referred to as burst disc. A diffuser adjoins to the cold gas storage on the other side. The diffusor may have one or more filling holes through which gas can be directed into the actual airbag. The invention is not limited to a specific design of the gas generator pipe. However, regardless of the shape, high pressure is generated when the gas generator is activated. According to the invention, the gas generator pipe can withstand this pressure due to the alloy used and the manufacturing process. In particular, the gas generator pipe has a high degree of toughness, which prevents the gas generator pipe product from bursting and in particular prevents splintering due to brittle fracture.

The steel alloy is also referred to hereinafter as alloy, steel or material. The contents of alloying elements are given in mass percent, but may also simply be referred to as a percentage.

Carbon (C) is necessary to produce the martensitic structure, which preferably contains austenite. According to the invention, carbon is added in an amount ranging from 0.05 to 0.18%. Preferably the carbon content is in the range of 0.06-0.13%. More preferably, the carbon content is less than 0.15%, for example 0.14%, or less than 0.12%, especially 0.10%. A minimum carbon content of 0.05%, preferably at least 0.06%, is required to achieve sufficient austenite stabilization during partitioning.

According to the invention, the steel alloy has a silicon (Si) content in the range of 0.4-2.6%. Due to its high affinity for oxygen, silicon can be used as a deoxidizer and is therefore present in most killed steel alloys. The presence of silicon in the specified quantities can prevent carbide formation, so that the carbon is available for stabilizing austenite. Preferably, silicon is present in an amount in the range of 1.0-2.6%, in particular 1.4-2.6%, preferably in the range of 1.7-2.4% and further preferably the silicon content is present in the range of 1.8-2.2%.

According to the invention, chromium (Cr) is present in an amount in the range of 2-4%. Preferably, chromium is present in an amount in the range of 2.1-3.8%, of 2.5 to 3.5% or 2.2-3.6% and particularly preferably is present in an amount of 3%. By adding chromium in these quantities, chromium can serve as a carbide former. By addition of carbide formers to iron-carbon alloys, at temperatures above the starting temperature of the intermediate stage structure bainite, also known as Bs (bainite starting temperature), an area in which no transformation takes place is formed. In the time-temperature transformation diagram, this is detectable by a complete separation of the transformation areas for ferrite/pearlite and bainite. This range, in which no transformation takes place, is internationally also referred to as bay. It has been detected that both the undesired bainite formation and the cementite formation are hindered at these temperatures, if carbide formers are added in a targeted manner.

Molybdenum (Mo) is present in the steel alloy in an amount in the range of 0.05-1.0%, preferably in the range of 0.1 to 0.6%, in particular 0.2 to 0.5%. The addition of molybdenum reduces temper brittleness.

Nitrogen (N) is contained in the alloy in a small amount of less than 0.015%, preferably in an amount in the range of 0.006-0.012%. Nitrogen can enter the alloy during steel production, for example during purging.

In addition, the steel alloy contains at least one alloying element to reduce suscep-tibility to hydrogen embrittlement. In particular, the steel alloy contains at least one of the alloying elements niobium (Nb), vanadium (V), aluminum (Al) and titanium (Ti). For example, both niobium and vanadium can be introduced into the steel alloy, in which case the sum of the contents of niobium and vanadium (Nb+V) is at most 0.5%. Preferably, only one of these two alloying elements (Nb, V) is introduced into the alloy.

Niobium (Nb) already acts as a carbide former during the manufacture of the hot tube, from which the gas generator pipe is preferably made, and thus causes a fine-grained structure of the gas generator pipe and thus an improved notch impact strength. Niobium is preferably added in an amount in the range of 0.015 to 0.1%.

Vanadium (V) is preferably added in an amount in the range of 0.025 to 0.5%. Vanadium also serves to form a fine-grained structure and improves the notch impact strength by forming nitrides and/or nitrocarbides during Q&P heat treatment. Therefore, vanadium is preferably added in an amount that meets the requirement of V=3.64*N.

Titanium (Ti) binds nitrogen contained in the alloy. This can prevent the formation of harmful boron nitrides, which would prevent through-hardening.

In addition, aluminum (Al) can be present in an amount in the range of 0.01-0.1%, preferably in the range of 0.015-0.06%.

According to the invention, the gas generator pipe is a gas generator pipe that has been subjected to quenching and partitioning heat treatment (Q&P) during manufacture.

As the gas generator pipe is manufactured from the novel alloy and has been subjected to Q&P heat treatment, the gas generator pipe product has high strength and good notch bar impact values and is cold formable.

According to one design, the steel alloy has a manganese content (Mn) of <2.0%. Alternatively, the manganese content can also be <0.7%. Preferably the manganese content is in the range of 0.2-1.4% and further preferably in the range of 0.3-0.9%.

Optionally, the steel alloy can contain nickel (Ni) in an amount of maximum 3%, preferably up to 0.5% and especially preferred of 0.1%.

Optionally, the steel alloy can contain boron (B). In this case the amount of boron is in the range of 0.001-0.004%. It has been detected that boron lowers the critical quenching rate for martensite. Thus, the required microstructure can be reliably adjusted. If no boron or too little boron is added to the alloy, austenite dissociation can occur during heat treatment, especially during quenching and partitioning (Q&P), which would in particular result in the formation of bainite before partitioning has begun.

Preferably, the gas generator pipe has a microstructure of martensite and austenite, with the proportion of austenite ranging from 5 to 20% and preferably less than 15%. In particular the portion of austenite is preferably in the range from 5 to 15%. The austenite is preferably present as fine-grained, lamellar austenite. The lower the austenite content, the finer its structure. Therefore, the austenite content is preferably limited to less than 15%.

In particular, the amount of austenite in the microstructure, measured at 1 mm depth from the outer surface of the pipe, is more than 5%. Over the thickness of the pipe wall, the austenite content shows a degressively increasing course and, at a distance from the outer surface of the pipe, a pronounced almost constant austenite content, so that, according to the invention, there is preferably a small overall scattering of the yield strength, elongation at break and notch impact strength.

Preferably the microstructure contains bainite, ferrite and/or pearlite in a total amount of less than 10%, preferably less than 5%.

Preferably the gas generator pipe has an energy absorption capacity, expressed by the product of tensile strength, Rm, and elongation at break, A5, of 18,000 MPa %.

Preferably the gas generator pipe has a transition temperature of −40° C. and preferably −60° C. The transition temperature, also known as Ductile-to-Brittle Transition Temperature (DBTT), defines the temperature at which the toughness properties transition from a high-energy level, which can simply be referred to as the high level, to a low-energy level, which can simply be referred to as the low level. Cooling below the transition temperature results in a sharp drop in impact energy and thus in brittle fracture. The transition temperature can be determined in a ring Charpy test, in which a ring-shaped section is cut out of the finished gas generator pipe, provided with a defined notch and then tested in a pendulum impact device. In particular, the gas generator pipe also exhibits ductile behavior down to −60° C. The Charpy impact strength is preferably measured according to the Japanese Standards Association (JSA) standard JIS Z 2242 in accordance with ISO 179, and the pipe burst pressure test is preferably performed according to ISO 1167; 1996 (E).

Examples of steel alloys that can be used for the gas generator pipe according to the invention are the following high-alloy steels

Alloy 1 (C: 0.10%, Cr: 3%, Si: 2%, Mo: 0.3%, Mn: 0.4%, Ni: 0.1% and Nb, preferably in the range 0.015-0.1%)

Alloy 2 (C: 0.14%, Cr: 2%, Si: 0.5%, Mo: 0.3%, Mn: 0.4%, Ni: 0.1% and Nb, preferably in the range of 0.015-0.1%)

Alloy 3 (C: 0.14%, Cr: 2%, Si: 1.3%, Mo: 0.3%, Mn: 0.4%, Ni: 0.1% and Nb, preferably in the range 0.015-0.1%)

Alloy 4 (C: 0.14%, Cr: 3%, Si: 1.3%, Mo: 0.3%, Mn: 0.4%, Ni: 0.1% and Nb, preferably in the range 0.015-0.1%).

As the chromium content or silicon content of these examples increases, the tech-nical characteristics, especially the tensile strength, rise. However, the cost of the steel alloy also increases.

The above task is further solved by a method for manufacturing the gas generator pipe with the features of claim 14. Advantageous embodiments of the method can be derived from the dependent claims as well as the present description and the figures.

Accordingly, a method for the manufacture of a gas generator pipe for airbag module according to the invention, is proposed. The method is characterized in that the method comprises a quenching step and a partitioning step, the quenching step comprising an active cooling phase and a subsequent passive cooling phase.

Advantages and features described with respect to the gas generator pipe apply—if suitable—to the method according to the invention and are therefore described only once, if necessary.

First, an austenitizing is performed before the quenching and partitioning steps. Inductive heating is preferred, so that the gas generator pipe can be heated very quickly to the target temperature. In combination with the alloy according to the invention, in particular the previously defined preferred niobium content, this ensures that there is only a small harmful grain growth of the austenite. Alternatively, rapid heating methods such as resistance heating or contact heating can be used.

By means of this heat treatment, the austenite, which is formed in large quantities in the alloy according to the invention, can be stabilized and thus the desired product properties can be specifically adjusted.

Q&P heat treatment produces a two-phase microstructure consisting essentially of low-carbon martensite, in particular tempered martensite, and austenite, hereinafter also referred to as retained austenite.

During the quenching step, the steel is first completely austenitized, i.e. heated to a temperature higher than the Ac3 temperature of the steel alloy, and then quenched to a temperature between the martensite start temperature and the martensite end temperature. Thus a part of the austenite is converted into martensite. Due to the suppressed iron carbide precipitation (cementite precipitation), the carbon diffuses from the supersaturated martensite to the retained austenite during the subsequent partitioning step. Carbon stabilizes the austenite, locally lowering the martensite starting temperature of the carbon-enriched austenite to below room temperature. Therefore, during final quenching to room temperature, no high-carbon martensite is formed and carbon-enriched austenite remains. The martensite, which is preferably tempered, increases the strength and the retained austenite continues to en-sure good elongation properties through the so-called Transformation Induced Plasticity Effect (TRIP effect).

According to the invention, quenching is optionally performed in two phases. This embodiment is particularly preferred for the production route where the gas generator pipe is manufactured from a bloom. In the first cooling phase, the bloom is preferably cooled to a temperature T1 at a cooling rate that is higher than the critical cooling rate of the alloy. T1 lies between the martensite start temperature (Ms temperature) and Ms+/−100° C. In the second, passive cooling phase, the bloom is cooled to a temperature T2 at a lower cooling rate, especially in air. This means that in the passive cooling phase the bloom is cooled by natural convection in air. Depending on the wall thickness, the outer diameter and the manufacturing process, the duration of the second cooling phase can be in the range of 60 s to 10 min. The temperature T2 is between 150° C. and the martensite start temperature (Ms). The specific temperature T2 depends on the carbon content of the alloy of which the gas generator pipe is made. The lower the carbon content, the higher the temperature T2 is chosen in the preferred range between 150° C. and Ms. The second, passive cooling phase results in a uniform temperature distribution in the pipe wall compared to a single-stage active cooling only, whereby, according to the invention, a low scattering of the yield strength, elongation at fracture, notch impact strength as well as the retained austenite content over the pipe wall is set. The retained austenite content or its scattering over the pipe wall can be determined very precisely in a known manner using a synchrotron, for example.

In one embodiment, at a 15 millimeter thick gas generator pipe according to the invention on the outside of the pipe at a measuring point close to the surface at a depth of 1 mm an austenite content of 10 percent, at a depth of 4 mm an austenite content of 20 percent was determined. This results in a scattering of the retained austenite content by a factor of approximately 2 over the pipe wall thickness. In contrast, rapid exclusively active cooling would result in an inhomogeneous wall temperature distribution and a retained austenite content of less than 5 percent near the surface on the outside.

According to an alternative embodiment, the gas generator pipe is cooled in the active cooling phase at a cooling rate greater than the critical cooling rate to a temperature T1, which lies between the martensite start temperature and the martensite start temperature minus 150° C. With this embodiment, the second passive cooling step is omitted. This embodiment is particularly advantageous for the production route for cut-to-length airbag pipes. The critical cooling rate denotes the cooling rate which is at least necessary for martensite formation.

In the partitioning step, the gas generator pipe or bloom is heated to a temperature T3 which is greater than the martensite start temperature of the steel alloy and preferably less than or equal to 500° C. and is held at this temperature. The duration of heating and holding is preferably in the range between 30 s and 1,200 s. The minimum duration is determined by the technology used for heating and provides a minimal but still sufficient partitioning effect. If the maximum duration is reached, no more positive influence on the partitioning effect is obtained. In addition, a too long holding at the temperature is associated with high costs and therefore no longer economical.

The heat treatment, especially the partitioning step, is preferably carried out with inductive heating. This allows the desired heating rates and holding phases to be adjusted in a targeted manner. After partitioning, the gas generator pipe is cooled down to room temperature in air or actively.

According to one embodiment, the method includes the step of cold forming, in particular cold drawing of at least a part of the gas generator pipe after the partitioning step. Due to the steel alloy used and the Q&P step, the gas generator pipe is suitable to be cold-formed after the partitioning step. Therefore, a cold drawing after the Q&P step can further increase the strength of the gas generator pipe and also compensate geometry tolerances. In addition, cold forming can also be used to form indents on the gas generator pipe, for example. This is also possible due to the good cold-forming properties of the gas generator pipe in accordance with the invention.

### BRIEF DESCRIPTION OF THE DRAWINGS

An embodiment of the invention is explained in more detail in the following description of the figures, wherein:

FIG. 1: shows a schematic representation of an embodiment of a gas generator pipe for an airbag module;

FIG. 2: shows a schematic representation of heat treatment according to a first embodiment of the invention;

FIG. 3: shows a schematic representation of heat treatment according to a second embodiment of the invention; and

FIG. 4: shows a pipe wall section of a gas generator pipe according to two embodiments of the invention with associated diagram of the austenite content in the pipe wall.

### DETAILED DESCRIPTION OF THE PREFERRED EMBODIMENTS

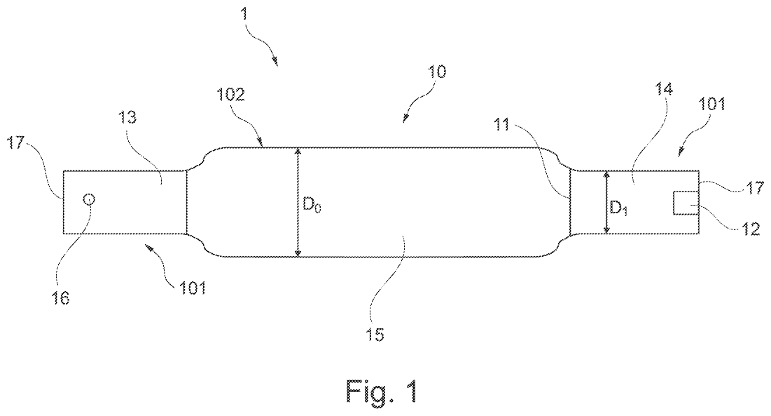

FIG. 1 shows an example of a gas generator 1 for an airbag module (not shown). Gas generator 1 comprises a gas generator pipe 10 according to the invention. In the embodiment shown in FIG. 1, the pipe ends 101 are tapered or drawn in. The taper of the pipe ends 101 can be produced by cold forming. In the embodiment shown in FIG. 1, the pipe ends 101 each have a diameter D1 which is smaller than the diameter D0 of the pipe element 10 in its middle area 102. The diameters of the pipe ends 101 can also be different. In the embodiment shown in FIG. 1, gas generator 1 has a combustion chamber 14, in which an igniter 12 and the other pyrotechnical components are provided. The combustion chamber 14 is closed at one pipe end 101 by a welded-on disc 17. The cold gas storage 15 adjoins the combustion chamber 14. The cold gas storage 15 is separated from the combustion chamber 14 by the membrane 11, which can also be referred to as a bursting disc. The cold gas storage 15 is located in the middle area 102 of the pipe element 10, which has the larger diameter D0. The cold gas storage 15 is connected to the diffuser 13. FIG. 1 shows a filling hole 16 in the area of the diffuser 13. The pipe end 101 of the diffuser 13 is welded to a disk 17, i.e. closed by it.

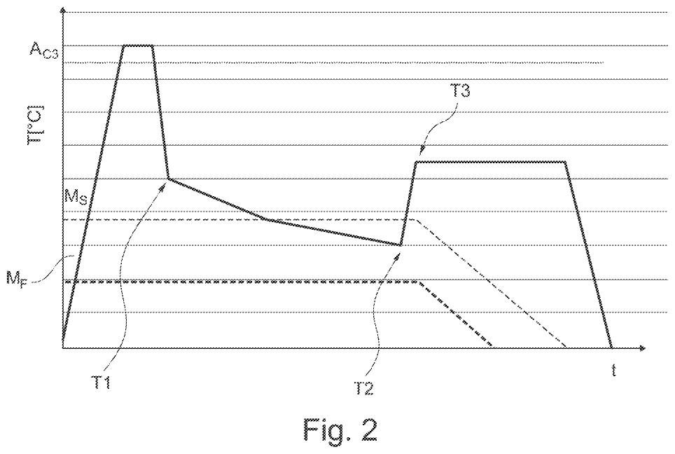

In FIG. 2 it is shown that the gas generator pipe, which in this embodiment can be present in the form of a bloom during heat treatment, is heated in a first step to a temperature higher than the Ac3 temperature of the material of the gas generator pipe. In a first quenching step, the gas generator pipe is cooled at a high cooling rate to a temperature T1 which, in the embodiment shown, is above the martensite start temperature, Ms. In this way, the quenching temperature can be reliably reached. In a second cooling step, the gas generator pipe is cooled down to a temperature T2, which is below the Ms temperature, by passive cooling, for example by transporting the gas generator pipe during production. In the partitioning step, the gas generator pipe is then heated to a temperature T3, which is above the Ms temperature, and held at this temperature.

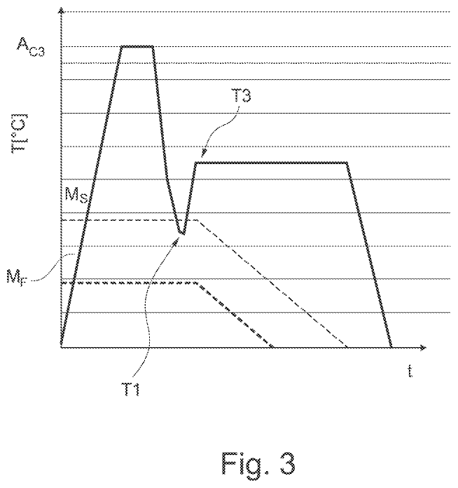

The method according to FIG. 3 differs from the first embodiment according to fig-ure 2 in that in the second embodiment in FIG. 3 the quenching step only includes one active cooling step. In this case, the gas generator pipe is cooled in the active cooling phase at a cooling rate greater than the critical cooling rate to a temperature T1, which lies between the martensite start temperature and the martensite start temperature—150° C. A passive cooling step is not performed. Instead, the gas generator pipe is heated directly from temperature T1 to a temperature T3 which is higher than the martensite start temperature, and preferably less than or equal to 500° C.

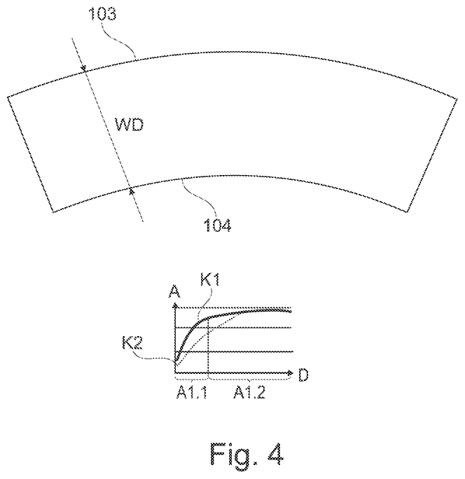

FIG. 4 shows a pipe wall section of a gas generator pipe with two-phase cooling according to the invention. The associated diagram shows on the horizontal axis the distance D or measuring point, measured from the outside of the pipe 103, and on the vertical axis the austenite content A. Curve K1 shows a degressively increasing austenite content A1.1 over the pipe wall from the outside to the inside of the pipe 104 and a pronounced almost constant austenite content A1.2 already at less than half of the pipe wall thickness WD. In comparison, curve K2 shows a gas generator pipe with only one active cooling. Both a comparatively low austenite content on the outside of the pipe and a significantly flatter increase are visible.

For example, in the cold gas storage 15 there can be a pressure of 580 bar. In the combustion chamber 14, for example, the pressure can increase from 580 bar to 1,200 bar, when the igniter is ignited. Due to its properties, the gas generator pipe, can reliably withstand this pressure without fear of brittle fracture or expansion of a brittle crack.

### REFERENCE NUMBERS

1 Gas generator
10 Gas generator pipe
101 Pipe end
102 middle area
103 pipe outside
104 pipe inside
11 membrane
12 igniter
13 diffuser
14 combustion chamber
15 cold gas storage
16 fill hole
17 disc
A austenite portion
D distance
WD wall thickness

1. Gas generator pipe of an airbag module, the gas generator pipe consisting of a steel alloy with a martensitic matrix, characterized in that the gas generator pipe has a tensile strength, Rm, of at least 1100 MPa, and the steel alloy has in mass percent (Ma %) the following alloying elements apart from iron and melt-related impurities:
C 0.05-0.18%
Si 0.4-2.6%
Mn 0.2-1.4%
Cr 2.0-4.0%
Mo 0.05-1.0%
N <0.015% and
at least one of the alloying elements Nb, V, Al and Ti, in total at least 0.01 Ma %,
the gas generator pipe has been subjected to quenching and partitioning heat treatment and
the gas generator pipe has a microstructure of martensite and austenite and the amount of austenite in the microstructure is at least 5%.

2. The gas generator pipe according to claim 1,
characterized in that the carbon content is less than 0.15 Ma %, for example 0.14 Ma %, or less than 0.12 Ma %, in particular in the range of 0.06 to 0.13 Ma %, and more preferably is 0.10 Ma %.

3. The gas generator pipe according to claim 1, characterized in that the silicon content is in the range of 1.0-2.6 Ma %, preferably in the range of 1.4-2.6 Ma %, preferably in the range of 1.7-2.4 Ma % and more preferably is 2 Ma %.

4. The gas generator pipe according to claim 1, characterized in that the chromium content is in the range of 2.1-3.8 Ma %, in particular in the range of 2.2-3.6 Ma %, preferably in the range of 2.5-3.5 Ma % and further preferably is 3 Ma %.

5. The gas generator pipe according to claim 1, characterized in that the manganese content is in the range of 0.3-0.9 Ma %.

6. The gas generator pipe according to claim 1, characterized in that the nitrogen content is in the range of 0.006-0.012 Ma %.

7. The gas generator pipe according to claim 1, characterized in that the alloy comprises boron in an amount in the range of 0.001-0.004 Ma %.

8. The gas generator pipe according claim 1, characterized in that at least one of the following alloying elements is present in the steel alloy in the indicated amounts in mass percent:
Nb 0.015-0.1%
V 0.025-0.5%
Ti 3.8*N-5.5*N.

9. The gas generator pipe according to claim 1, characterized in that the steel alloy comprises nickel, Ni, in an amount of at most 3 Ma %, preferably up to 0.5 Ma % and most preferably up to 0.1 Ma %.

10. The gas generator pipe according to claim 1, characterized in that the gas generator pipe has a microstructure of martensite and austenite and the amount of austenite in the microstructure is preferably in the range of 5 to 20%, in particular in the range of 5 to 15%.

11. The gas generator pipe according to claim 10, characterized in that the amount of austenite in the microstructure, determined at 1 mm depth measured from the outer surface of the pipe, is more than 5%.

12. The gas generator pipe according to claim 10, characterized in that the microstructure comprises bainite, ferrite and/or pearlite in a total amount of less than 10%, preferably less than 5%.

13. The gas generator pipe according to claim 1, characterized in that the gas generator pipe has an energy absorption capacity, expressed by the product of tensile strength, Rm, and elongation at break, A, of 18,000 MPa %, determined on a round sample with an elongation measurement length of 20 mm.

14. The gas generator pipe according to claim 1, characterized in that the steel alloy has a transition temperature of −40° C. and preferably −60° C.

15. A method for manufacturing a gas generator pipe for an airbag module, the method comprising:
providing a gas generator pipe of an airbag module, the gas generator pipe consisting of a steel alloy with a martensitic matrix, characterized in that the gas generator pipe has a tensile strength, Rm, of at least 1100 MPa, and the steel alloy has in mass percent (Ma %) the following alloying elements apart from iron and melt-related impurities:
C 0.05-0.18%
Si 0.4-2.6%
Mn 0.2-1.4%
Cr 2.0-4.0%
Mo 0.05-1.0%
N <0.015% and
at least one of the alloying elements Nb, V, Al and Ti, in total at least 0.01 Ma %,
the gas generator pipe has been subjected to quenching and partitioning heat treatment and
the gas generator pipe has a microstructure of martensite and austenite and the amount of austenite in the microstructure is at least 5%;
characterized in that the method comprises a quenching step and a partitioning step, the quenching step comprising an active cooling phase and optionally a subsequent passive cooling phase.

16. The method according to claim 15, characterized in that in the active cooling phase the gas generator pipe is cooled at a cooling rate greater than the critical cooling rate to a temperature T1 which is between martensite start temperature +/−100° C., and in a second passive cooling step in air to a temperature T2 which is preferably greater than 150° C. and less than the martensite start temperature.

17. The method according to claim 15, characterized in that in the active cooling phase the gas generator pipe is cooled at a cooling rate greater than the critical cooling rate to a temperature T1 which is between martensite start temperature and martensite start temperature minus 150° C.

18. The method according to claim 15, characterized in that in the partitioning step the gas generator pipe is heated to a temperature T3 which is greater than the martensite start temperature and less than or equal to 500° C. and is held at his temperature.

19. The method according to claim 15, characterized in that the method comprises a step of cold forming, in particular cold drawing, of at least part of the gas generator pipe after the partitioning step.
